(19) United States
(12) Patent Application Publication
(10) Pub. No.: US 2011/0313333 A1
(43) Pub. Date: Dec. 22, 2011

(54) MASSAGE SYSTEM

(76) Inventor: Randy NICHOLSON, Marietta, GA (US)

(21) Appl. No.: 13/166,420

(22) Filed: Jun. 22, 2011

Related U.S. Application Data
(63) Continuation-in-part of application No. 11/924,366, filed on Oct. 25, 2007, now abandoned.

(51) Int. Cl. A61H 15/00

(52) U.S. Cl. 601/120

(57) ABSTRACT

A massage kit including an active health roller massage implement and a stand for supporting the active health roller implement. The active health roller implement has an elongated central semi-rigid axle, at least two handles coupled to and transverse to the central axle, and a plurality of substantially spherical rollers rotatably coupled to the central axle. A method of using the massage kit includes supporting the active health roller implement on the stand in a fixed position, resting a body part on the rollers, and moving the body part across the rollers.

### CROSS-REFERENCE TO RELATED APPLICATIONS

This application is a continuation-in-part of U.S. Non-Provisional Patent Application Ser. No. 11/924,366, filed on Oct. 25, 2007, which claims the priority benefit of U.S. Provisional Patent Application Ser. No. 60/862,908, filed on Oct. 25, 2006, both of which are hereby incorporated herein by reference in their entireties for all purposes.

### TECHNICAL FIELD

The present invention relates generally to the field of massage, and more particularly, to an implement that can be used to administer massages.

### BACKGROUND

Exercising is very beneficial to the human body. There are numerous ways that people exercise to keep their bodies in shape, such as running, cycling, swimming, weightlifting, etc. However, after a person exercises, their bodies release lactic acid and toxins into the cells of muscles that were exercised. These toxins can cause muscle soreness and fatigue. Exercising can also create tiny tears in the muscle fibers that develop scar tissue when they heal. Eventually, the accumulation of scar tissue can become painful. Moreover, these conditions apply to many other species of animals as well as humans, for example, horses, cows, dogs, cats, etc.

Often people (or other animals) injure their muscles more severely, whether through exercising, at work, or just through normal day-to-day activities. These types of muscle injuries often require rehabilitation to facilitate muscle healing. Other people routinely suffer from chronic joint pain or mobility problems that are created by shortened muscle fibers. It has been known that massage can be very therapeutic to injured muscles and can help relieve mobility problems caused by shortened muscle fibers. Massage therapy can increase blood flow to muscle tissue, lengthen muscle fibers, break up scar tissue, and alleviate muscle and joint pain. Known massage implements often only massage muscle tissue near the surface of the skin and are unable to engage deep muscle tissue. For example, a commonly used massage implement known commercially as the “stick” uses a plurality of cylindrical rollers to massage shallow muscle tissue. However, because of the cylindrical nature of the rollers, a user is not able to “dig” into the underlying deep muscle tissue to increase blood flow, release lactic acid, and/or alleviate scar tissue therein.

Thus it can be seen that needs exist for improvements that provide for massaging shallow and deep muscle tissue while releasing lactic acid and other toxins from the muscle tissue and/or while breaking up scar tissue in the muscle fibers. It is to the provision of these needs and others that the subject matter of the present invention is primarily directed.

### SUMMARY

The present invention relates to a massage kit including an active health roller implement and a stand to support the active health roller implement above a surface. The active health roller implement has an elongated central axle, at least one handle coupled to the central axle, a plurality of rollers rotatably coupled to the central axle. The rollers are preferably generally spherical and include elongated slots generally parallel to the central axis, with each of the rollers operable to rotate independently of the other rollers. The at least one handle is preferably oriented generally transverse to the central axle for compactness, ergonomic use, and stability when used with the stand. The central axle is preferably semi-rigid so that applying force to the at least one handle results in pressure being applied by the rollers to the user's skin with the axle deforming to generally conform to the shape of the treated body area so the rollers contact and treat the intended body area.

A method of using the entire massage kit includes supporting the active health roller implement on the stand in a fixed position, resting on the rollers a body area to be treated, and moving the body area across the rollers with the rollers supporting the user's weight. And a method of using the active health roller implement by itself includes grasping the at least one handle, positioning the rollers on a body area to be treated, and applying pressure to the at least one handle while moving the rollers over the body area to be treated. In these ways, a user is able to “dig” into muscle tissue to help lengthen the muscle fibers, remove scar tissue, alleviate trigger points, increase blood flow to the area, and increase muscle flexibility.

In the some embodiments, the rollers are substantially the same size and shape, while in other embodiments the rollers have different sizes and/or shapes. In some embodiments, the rollers are provided with the axial elongated slots, while in other embodiments they have no slots, and in still other embodiments they are provided with another arrangement of recesses such as generally tessellated dimples. In some embodiments, the implement includes two transverse handles, one at each end of the central axle, while in other embodiments the implement includes only one handle, and in still other embodiments the implement includes one or more handles that are inline or otherwise not transverse to the central axle. And in some embodiments, the implement and stand are provided as a kit, while in other embodiments the implement is provided by itself.

These and other aspects, features and advantages of the invention will be understood with reference to the drawing figures and detailed description herein, and will be realized by means of the various elements and combinations particularly pointed out in the appended claims. It is to be understood that both the foregoing general description and the following brief description of the drawings and detailed description of example embodiments are exemplary and explanatory of certain embodiments of the invention, and are not restrictive of the invention, as claimed.

### BRIEF DESCRIPTION OF THE DRAWINGS

FIG. 1 is a perspective view of a massage implement according to a first example embodiment of the present invention.

FIG. 2 is a partially exploded perspective view of a portion of the massage implement of FIG. 1.

FIG. 3 is a perspective view of a massage implement according to an alternative example embodiment of the present invention.

FIG. 4 is a perspective view of a massage implement according to another alternative example embodiment of the present invention.

FIG. 5 is a perspective view of a massage implement according to another alternative example embodiment of the present invention.

FIG. 6 is a perspective view of a massage implement according to another alternative example embodiment of the present invention.

FIG. 7 is a perspective view of a massage implement according to another alternative example embodiment of the present invention.

FIG. 8 is a front view of a massage implement according to another alternative example embodiment of the present invention.

FIG. 9 is a perspective view of a stand according to a first example embodiment of the present invention for use with the massage implement of FIG. 1.

FIG. 10 is an end view of a portion of the stand of FIG. 9.

FIG. 11 is a perspective view of a stand according to a second example embodiment for use with a massage implement according to a second example embodiment.

FIG. 12 shows the massage implement of FIG. 11 by itself without the stand.

FIG. 13 shows the massage implement of FIG. 12 partially exploded.

FIG. 14 is a front view of the massage implement of FIG. 12.

FIG. 15 is a right end view of the massage implement of FIG. 14.

FIG. 16 is a top view of the massage implement of FIG. 14.

FIG. 17 is a perspective view of one of the rollers of the massage implement of FIG. 12.

FIG. 18 is a right end view of the roller of FIG. 16.

FIG. 19 is a front view of the roller of FIG. 16.

FIG. 20 is a cross-sectional view of the roller taken at line 20-20 of FIG. 19.

FIG. 21 is a cross-sectional view of the roller taken at line 21-21 of FIG. 19.

FIG. 22 is a perspective view of one of the handles of the massage implement of FIG. 12.

FIG. 23 is another perspective view of one of the handles of the massage implement of FIG. 12.

FIG. 24 is a front view of one of the handles of the massage implement of FIG. 12.

FIG. 25 is a top view of the handle of FIG. 24.

FIG. 26 is a left end view of the handle of FIG. 25.

FIG. 27 is a right end view of the handle of FIG. 25.

FIG. 28 is a cross-sectional view of the handle taken at line 28-28 of FIG. 17.

FIG. 29 is a perspective view of one of the bases of the stand of FIG. 11.

FIG. 30 is a left end view of the stand base of FIG. 29.

FIG. 31 is a top view of the stand base of FIG. 30.

FIG. 32 is a front view of the stand base of FIG. 30.

FIG. 33 is a perspective view of a massage implement of the present invention in use with a stand of the present invention to massage a user's neck.

FIG. 34 is an end view of the massage implement, stand, and user of FIG. 33.

FIG. 35 is a front view of the massage implement and the stand of FIG. 33 with the user's neck shown in cross section to illustrate the semi-rigid axle deforming to generally conform to the shape of the user's neck.

FIG. 36 is a perspective view of a massage implement of the present invention in use with a stand of the present invention to massage a user's leg.

FIG. 37 is an end view of the massage implement, stand, and leg of FIG. 36.

FIG. 38 is a perspective view of a massage implement of the present invention in use with a stand of the present invention to massage a user's arm.

FIG. 39 is an end view of the massage implement, stand, and arm of FIG. 38.

### DETAILED DESCRIPTION OF EXAMPLE EMBODIMENTS

The present invention may be understood more readily by reference to the following detailed description taken in connection with the accompanying drawing figures, which form a part of this disclosure. It is to be understood that this invention is not limited to the specific devices, methods, conditions, or parameters described and/or shown herein, and that the terminology used herein is for the purpose of describing particular embodiments by way of example only and is not intended to be limiting of the claimed invention. Also, as used in the specification including the appended claims, the singular forms “a,” “an,” and “the” include the plural, and reference to a particular numerical value includes at least that particular value, unless the context clearly dictates otherwise. Ranges may be expressed herein as from “about” one particular value to “about” another particular value. When such a range is expressed, another embodiment includes from the one particular value and/or to the other particular value. Similarly, when values are expressed as approximations, by use of the antecedent “about,” it will be understood that the particular value forms another embodiment.

Generally described, the present invention provides an active health roller implement (also referred to herein as a massage implement) that includes at least one handle, at least one roller, and a central support axle, and that can be used by itself and/or in conjunction with a stand for supporting the massage implement above a surface (e.g., a floor or ground surface). The massage implement can be used to massage deep and shallow muscle tissue while stripping the muscle of scar tissue. The massage implement can also alleviate muscle pain by relieving myofascial trigger points within the muscle tissue and/or by releasing lactic acid and other toxins from a person's muscle. By routinely utilizing the massage implement to massage a muscle area, blood flow to the particular muscle may be increased, thereby allowing for faster healing times after exercising or after experiencing a muscle injury. As such, the massage implement can be utilized in physical therapy, muscle rehabilitation, massage therapy, along with patients diagnosed with degenerative muscular diseases and/or arthritis. The massage implement can also be used to “warm-up” muscles before engaging in exercise. The massage implement can be self-administered or a first person/user can administer the massage implement on a second person/subject or even a pet or other animal.

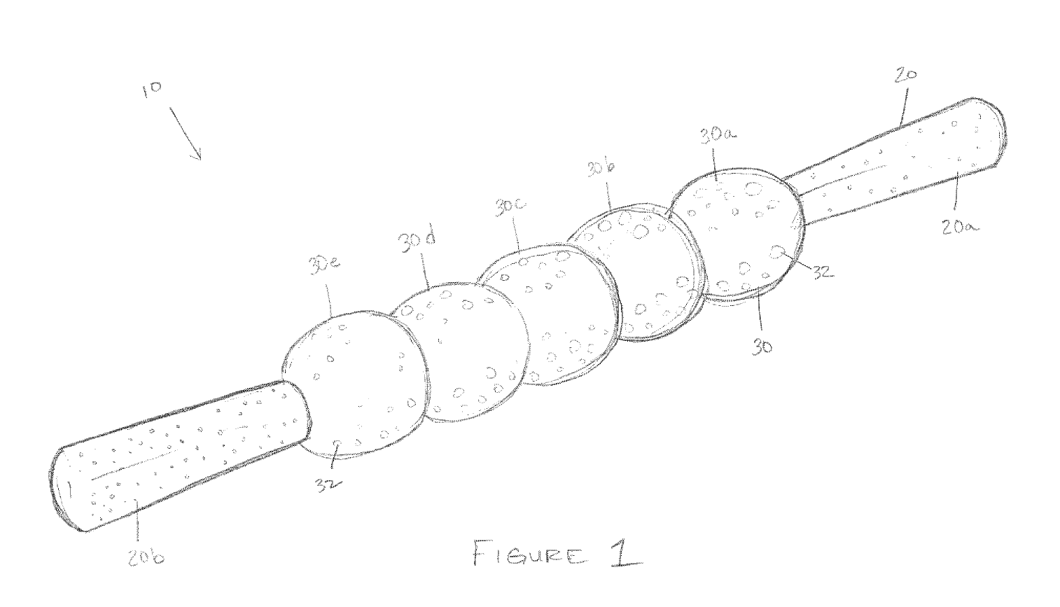

With reference now to the drawing figures, FIGS. 1-2 depict a massage implement 10 according to a first example embodiment of the present invention. The implement 10 has two handles 20a, 20b on opposing distal ends of the central axle 40 for the user to hold on to when administering a treatment. The handles 20a, 20b can have frictional gripping surfaces, such as those used with golf club grips. Indeed, in a typical commercial embodiment, the handles 20a, 20b are provided by conventional golf club grips mounted onto the axle 40. In the depicted embodiment, the two handles 20a, 20b are axially inline with the axle 40, though in other embodiments only one handle is provided and/or they are not axially aligned.

In the depicted embodiment, five rollers 30a-e (collectively, “the rollers 30”) are rotationally carried on the axle 40. In alternative embodiments, more or fewer rollers are used depending on the specific application and overall length of the implement 10. It has been found that five rollers 30 are particularly suitable for use with massage. However, it should be noted that nothing in this specification should be construed as limiting the number of balls or rollers 30 to any particular number, as the number of rollers can vary widely.

The rollers 30 rotate freely on the central support axle 40, which extends through bores passing through the centers of the rollers. The rollers 30 rotate independently of each other (at least two of them do, anyway). To facilitate the ease of rotation of the rollers 30 about the axle 40, conventional bearings can be used between the rollers and the axle.

The rollers 30 can be spherical, elliptical, cylindrical, or other rounded three-dimensional shapes. Alternatively, the rollers can be pointed, have multiple protrusions, or have other regular or irregular shapes. In typical commercial embodiments, rollers 30 having a spherical shape (i.e., a ball shape) are used and have proven very effective. The use of the spherical rollers 30 has been found to allow for excellent traction on human/animal skin without ripping out hair or sliding along the skin and while still providing an effective rolling action. The rounded rollers 30 also provide deeper muscle penetration and pressure on deep muscle tissue. The hardness of the rollers 30 can range from soft and flexible to hard and dense depending on the particular needs of the user. The size of the rollers 30 can vary with the application, and can range from about ½ inch in diameter to about 3 or more inches in diameter. In a typical commercial embodiment, rollers having the shape, hardness, and dimensions of a golf ball have been found to be effective, wherein the rollers are approximately 1.7 inches in diameter and weigh approximately 1.6 ounces. Indeed, conventional golf balls have modified for suitable for use as the rollers 30 in typical commercial embodiments. Whether using golf balls or other spherical or non-spherical rollers, including generally tessellated/honeycombed dimples 32 (as in conventional golf balls) or other recessed surfaces in the surface of the rollers 30 provides frictional surfaces/edges that help the rollers to rotate about the axle 40 when in use.

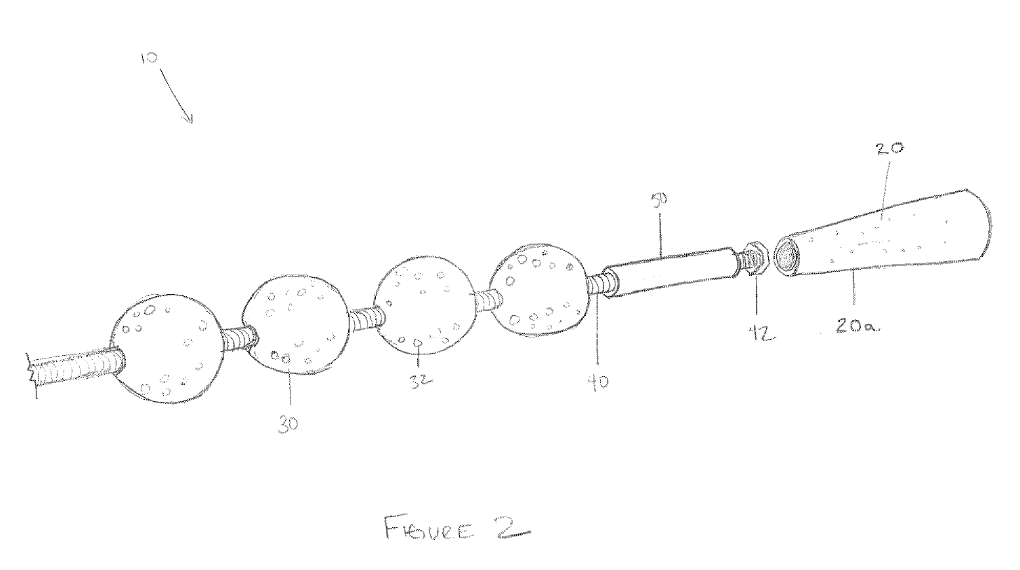

In the depicted embodiment, the rollers 30 all have the identical shape and size. In alternative embodiments, one or more of the rollers have different sizes and/or shapes. For example, in the alternative embodiment of FIG. 3, the center roller 30c is larger than the other rollers such that the user can concentrate pressure on a centralized area of the massage implement 10. In other embodiments, the rollers 30 can be interchangeable such that a user can utilize a particular customized combination of rollers having the desired size, hardness, and number of rollers. In such embodiments, one of the handles can be removed from the central axle, each of the rollers can be slid off the central axle, one or more substitute rollers can be slid onto the central axle, and the handle reattached.

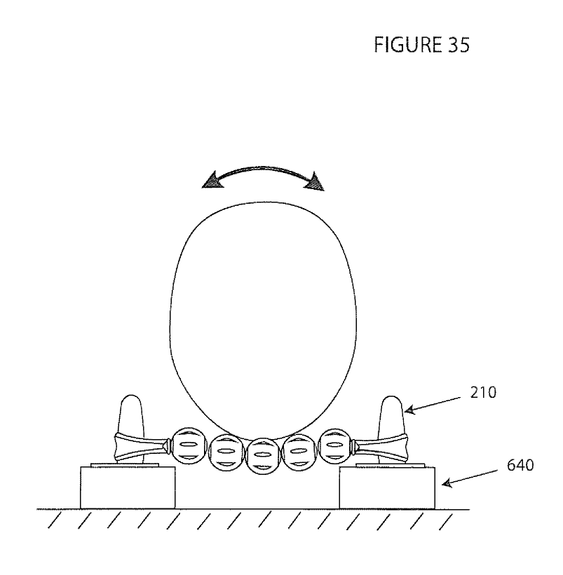

The central axle 40 is “semi-rigid,” meaning that applying force to the handles 20a, 20b results in pressure being transferred to the rollers 30 and applied by the rollers 30 to the user's skin with the axle bending/deforming to generally conform to the contour (e.g., curved) of the treated body area without breaking so that multiple (if not all) of the rollers contact and are free to roll under pressure against the intended body area (see, e.g., FIG. 35). Preferably, the central axle 40 is semi-rigid in this way yet is also sufficiently strong that it can withstand the full weight of an average adult human (for example when standing on the rollers) without breaking. In the depicted embodiment, for example, the central axle 40 is provided by a threaded metal rod having a diameter that is at least about ¼ inch in diameter. In some alternative embodiments, a smooth axle (or other elongate rod) is used, and in other alternative embodiments, the axle is made of plastic, wood, rubber, a composite, and/or another semi-rigid material. In alternative embodiments, the axle is “rigid,” meaning that it does not bend or deflect even under the full weight of an average adult human (for example when standing on the rollers).

The central support axle 40 connects at its distal ends to the handles 20a, 20b by threading at least one nut 42, which is coupled to the distal ends of the handles, over the threaded axle 40, or by using other conventional fasteners for securing the same. The at least one nut 42 is coupled to the handles with glue, epoxy, or other conventional fasteners. The interiors of the handles 20a, 20b are also preferably lined with a sleeve or bearing 50. The sleeve 50 can be plastic, metal, and/or other suitable materials. The sleeve 50 can be selected for having a greater rigidity than the semi-rigid axle 40 such that portions of the axle within the roller bores do not bend/deflect (or do so only minimally) so that the rollers 30 do not bind and lock against rotation (that is, the axle only bends at portions between the rollers). Furthermore, the rollers 30 can be provided with low-friction spacers, collars, rounded surfaces, etc., at their interfaces so that the rollers do not bind and lock against rotation when the semi-rigid axle 40 bends during use.

The overall length of the massage implement 10 can vary with the particular application, but generally, the massage implement is between about 12 and about 24 inches. However, the massage implement 10 can be shorter than about 12 inches, or greater than about 24 inches in length. In typical commercial embodiments, the massage implement is about 15 inches in length.

In use, a user of the massage implement 10 can grasp the handles 20a, 20b at the distal ends of the implement and apply the rollers 30 to the muscle or body area to be massaged or otherwise treated. The user can then apply force to the handles 20a, 20b, which distributes the force to the rollers 30 that are in contact with the area to be massaged. To massage the muscles, a user then moves the rollers 30 back and forth over the area to be massaged, focusing the majority of the force on the center roller 30c. Because of the rounded shape of the rollers 30, a user is able to effectively “dig” into the muscles and alleviate scar tissue, stretch muscle fibers, and increase blood flow to the area in an effective manner.

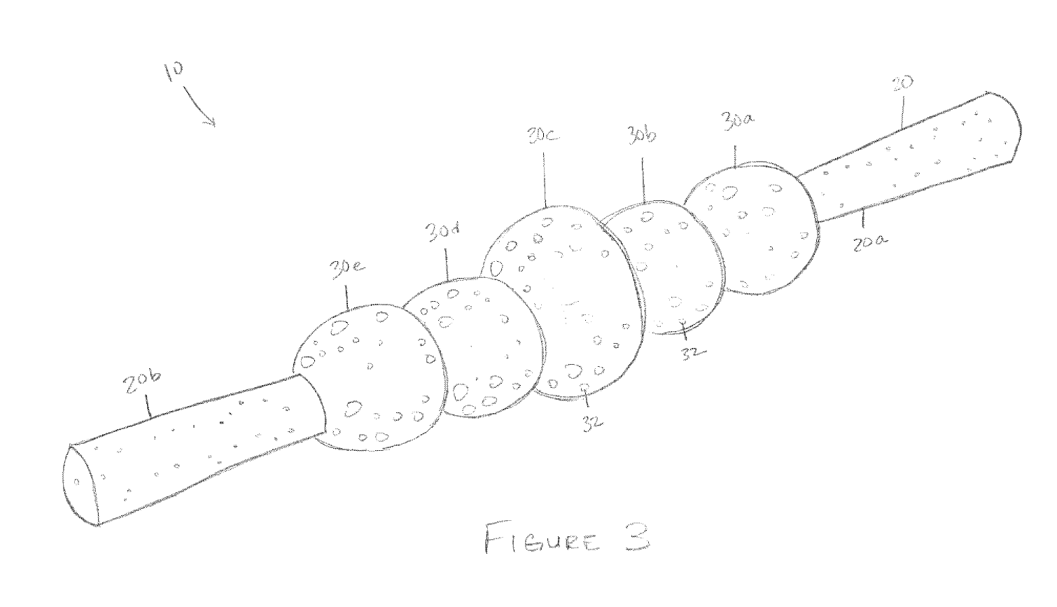

In situations wherein the user wishes to massage an area on his/her body in which two hands are not available for applying pressure, embodiments having only one handle can be used. For example, massage implements 10′, 10″ having only one handle 20′, 20″ can be used, as seen in the alternative embodiments of FIGS. 4-5. The single handle 20′, 20″ can be an ergonomic gripping handle.

In addition to being used on humans, the massage implement 10 of the present invention can also be used to massage animals, such as horses, dogs, cats, etc. The massage implement 10 can be sized to accommodate a particular type of animal, for example, a larger massage implement (being longer and having larger rollers 30) can be used to massage a horse, whereas a smaller implement can be used to massage a dog. It has been found that the massage implement 10 of the present invention is particularly useful in the treatment of horses.

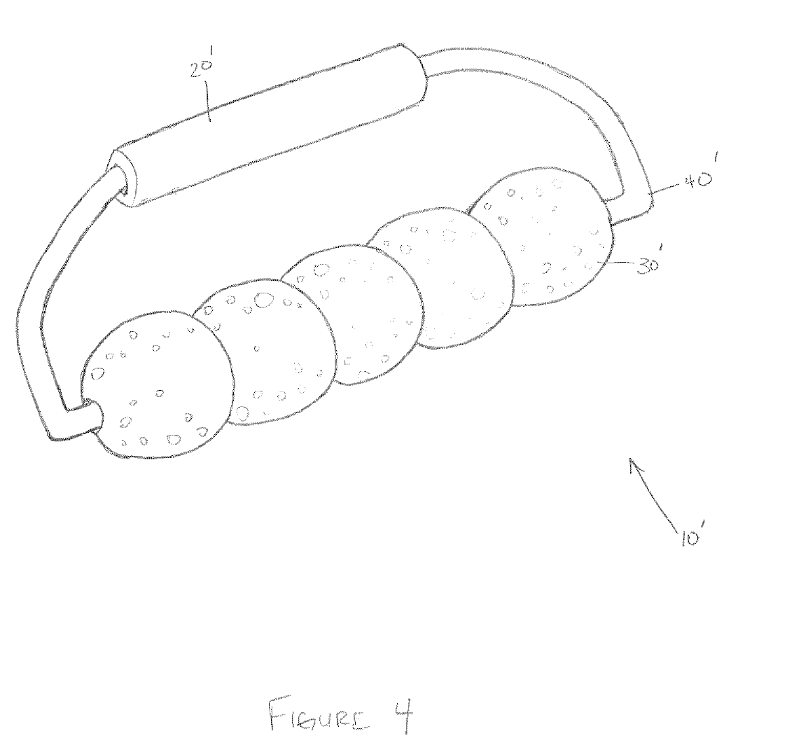

Additional alternative embodiments of the present invention are shown in FIGS. 6-8. FIG. 6 shows an alternative-embodiment massage implement 110 having two handles 120a, 120b and a plurality of rollers 130. Each roller 130 includes frictional grips 132 protruding from the outside surface of the roller to help rotate the rollers when the implement 110 is engaged and moved about a subject's skin. Alternatively, as seen in the two alternative-embodiment massage implements 110 of FIGS. 7-8, the frictional grips 132′, 132″ can be recessed into the outside surface of the rollers 130. Although FIGS. 6-8 show specific shapes and patterns of protruding and recessed gripping surfaces, in other embodiments the shapes, patterns, textures, and sizes of the gripping surfaces can be modified as desired.

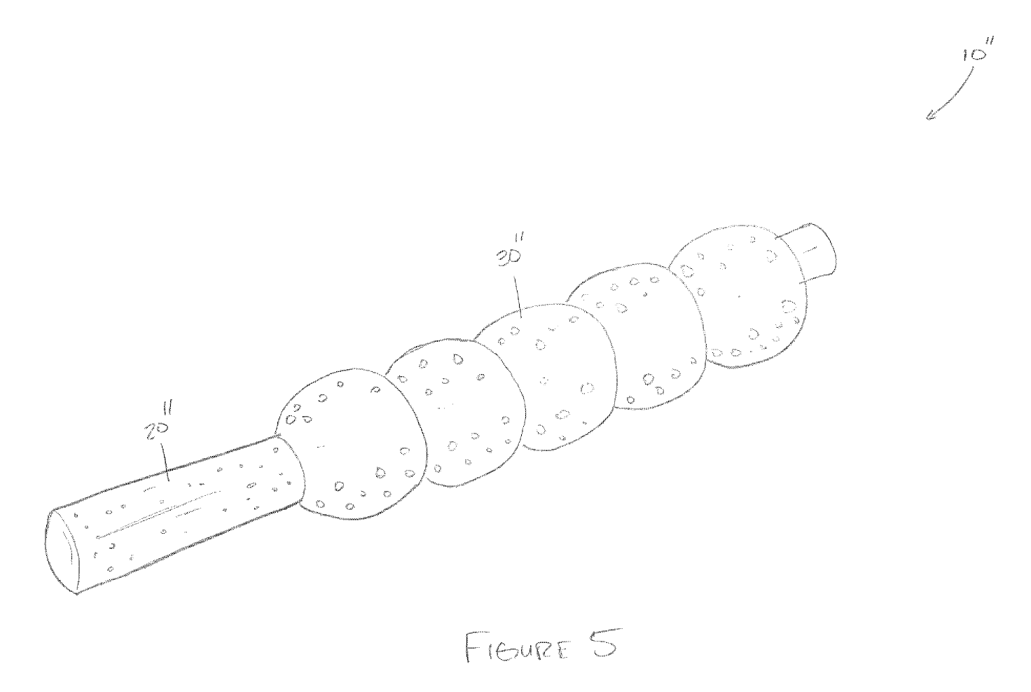

In another aspect, the present invention includes a stand for supporting a massage implement for storage and/or use. In a first example embodiment shown in FIGS. 9-10, the stand 500 is designed for supporting a massage implement 10 such as any of the example massage implements described herein. The stand 500 generally includes an elongated base 510 for elevating the massage implement 10 above the floor or other surface and at least one recess 520 formed therein to receive at least a portion of the massage implement. In the depicted embodiment, the at least one recess is provided by two substantially parallel and aligned channels 520a, 520b in the base 510 for receiving and supporting the handles 20a, 20b of the massage implement 10 therein. Alternatively, more channels or other types of recesses can be used as desired. The base 510 includes an intermediate recessed portion 530 extending between spaced-apart end portions 540, with the end portions defining the channels 520a, 520b and with the intermediate recessed portion having a vertical height that is shorter than the end portions so that the stand forms a cradle, as best seen in FIG. 9. As such, the rollers 30 of the massage implement 10 are permitted to rotate freely within the recess defined by the intermediate recessed portion 530 while the implement is resting securely on top of the stand 500.

In addition, the stand 500 can be imprinted with, or otherwise carry or be provided with, instructions on how to use the massage implement 10, the stand, or both the implement and stand together. For instance, typical commercial embodiments of the stand include an instructional diagram on the bottom of the stand as a reference guide for users.

In use, the handles 20 of the massage implement 10 can be seated within the recessed channels 520 of the stand to secure and support them in a fixed position. When the massage implement 10 has been positioned in this manner, the stand 500 substantially limits movement of the massage implement 10 when the implement is resting on top of the stand (as shown in FIG. 9), while at the same time permitting the rollers 30 to rotate freely. As such, a user can massage hard to reach areas of the body by moving a particular appendage or other body part over the massage implement 10. For instance, a user can sit on the floor and place his/her leg on top of the implement/stand combination to massage the back of the user's calf muscle. Similarly, other hard-to-reach body parts can be massaged, such as a user's back, foot, ankle, shoulder, etc. without assistance from another person.

In another aspect, the present invention provides a massage kit including a massage implement 110 and a stand 500 of any of the types described herein. The kit can also include a set of instructions and/or diagrams on how a user can utilize the massage implement and stand.

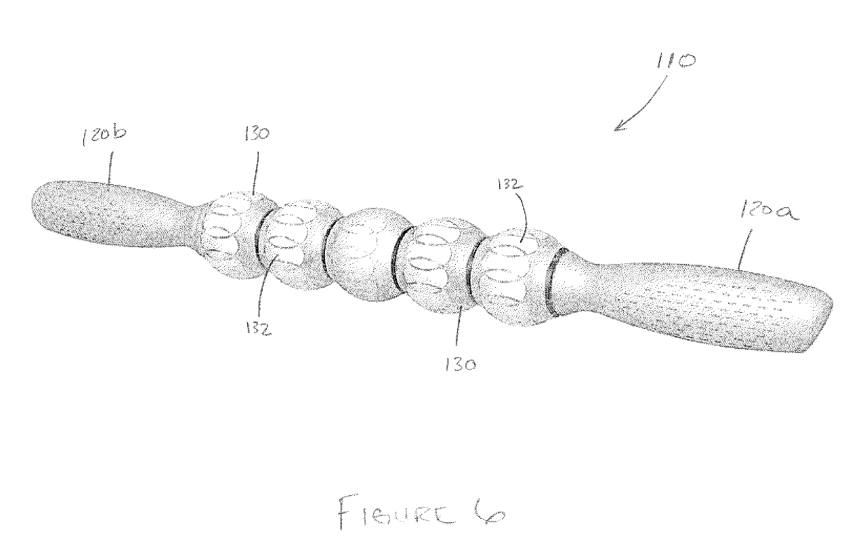

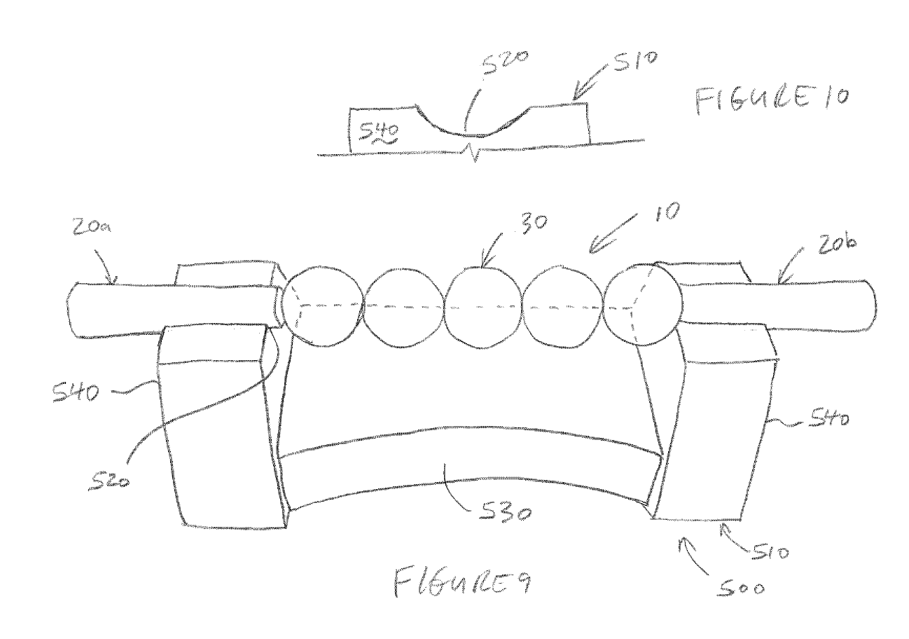

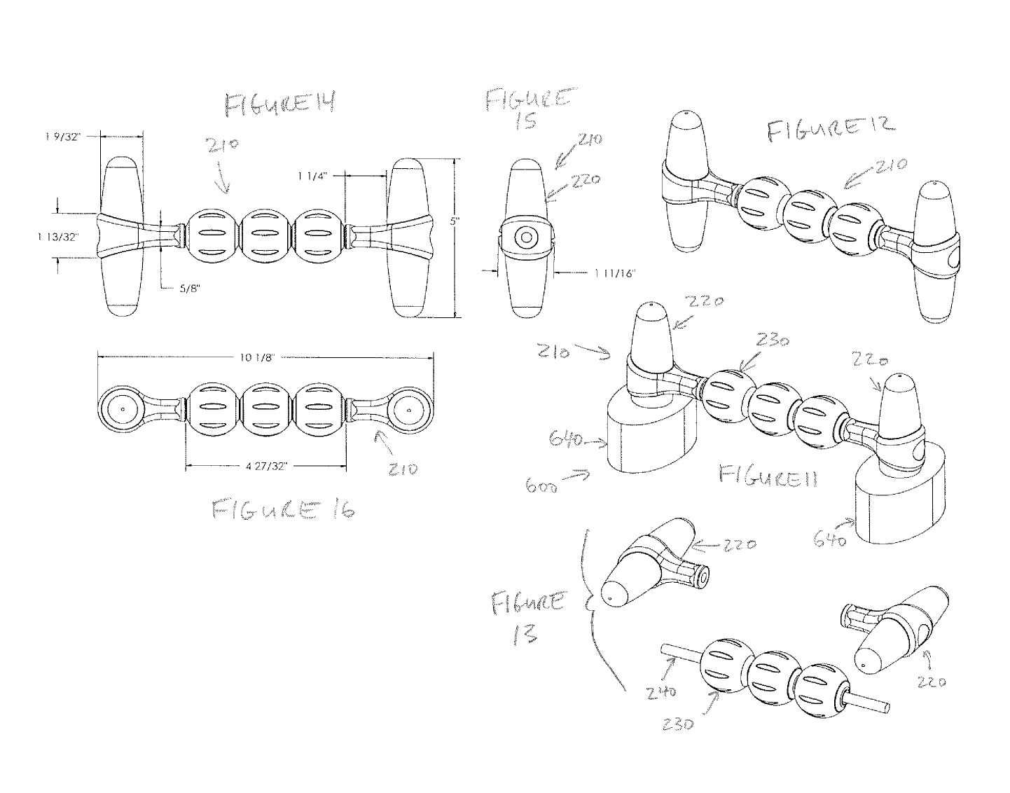

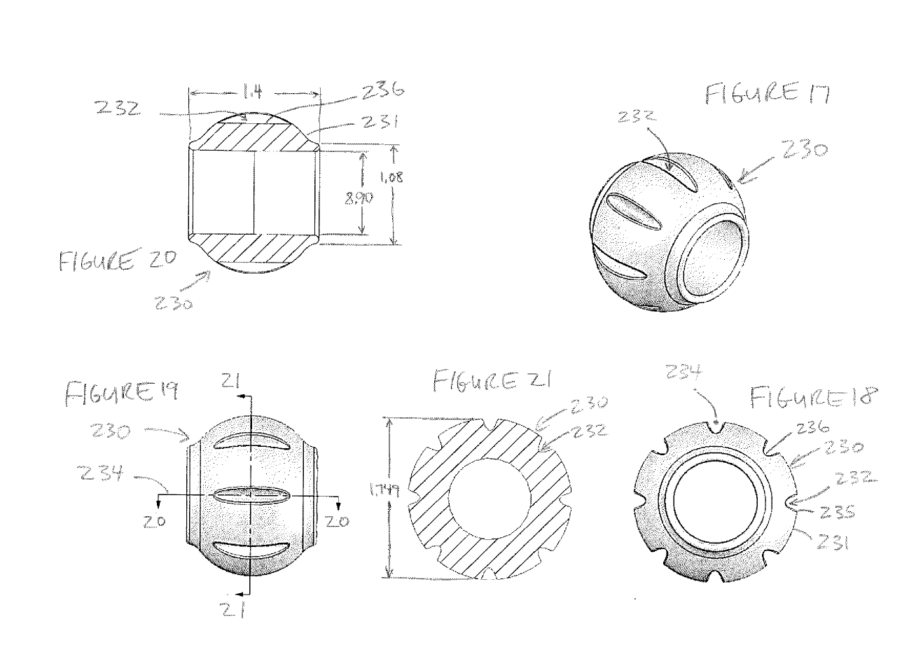

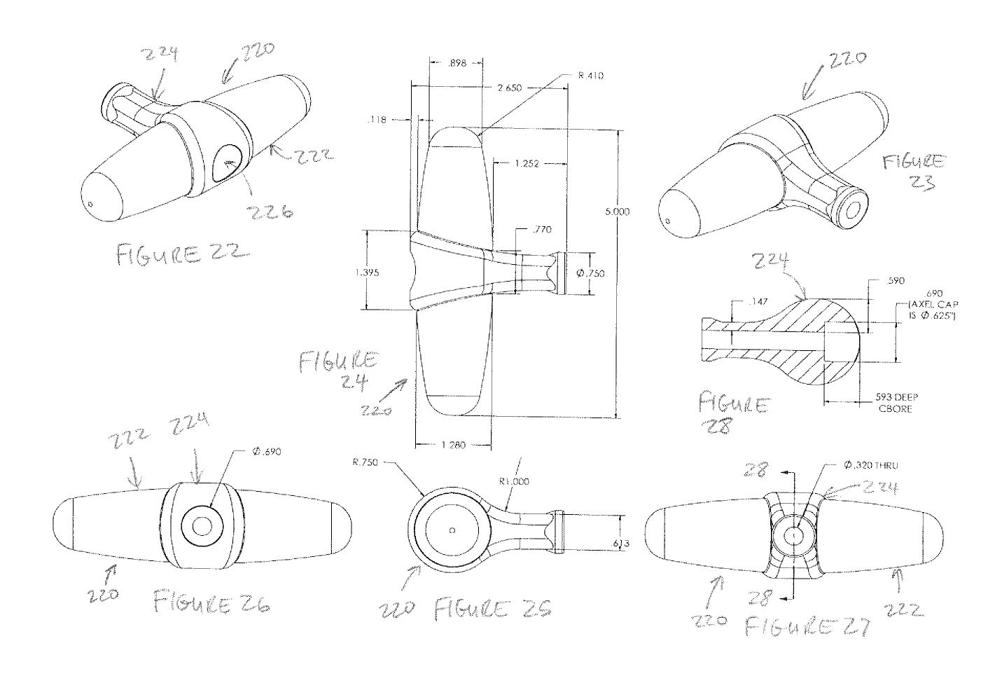

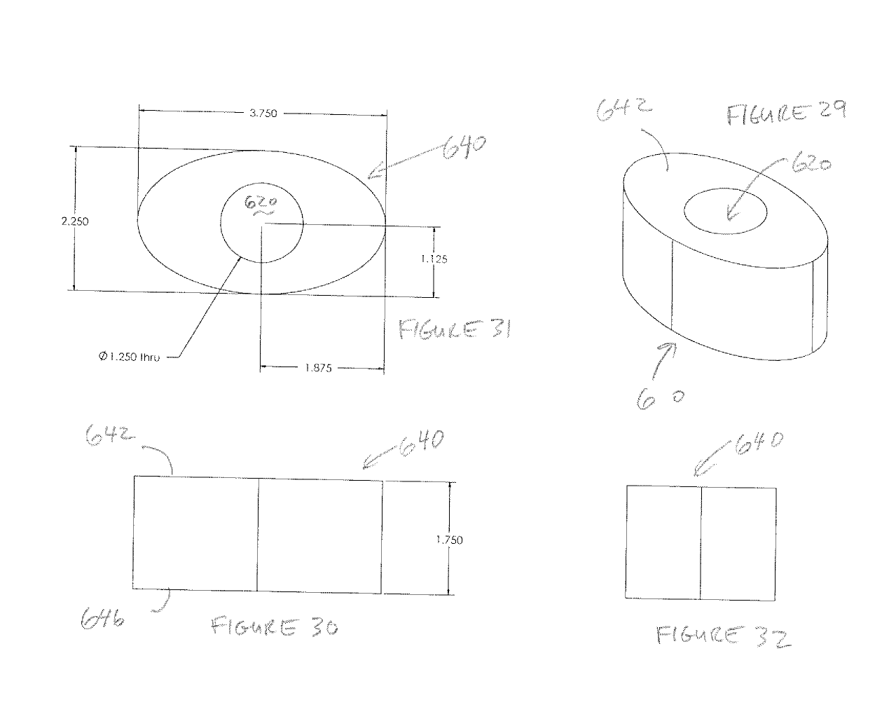

Referring now to FIGS. 11-32, there is shown a massage implement 210 and stand 600 according to a second example embodiment of the invention. The massage implement 210 and stand 600 are similar to the other example embodiments described herein. For example, the massage implement 210 includes an elongate central axle 240, a plurality of rollers 230 rotationally mounted on the axle, and two handles 220 mounted at opposing distal ends of the axle with the rollers between them. And the stand 600 includes two base end portions 640 that each define a recess 620 for receiving a respective one of the implement handles 220 to support the implement 210 above a floor or other surface with the rollers 230 unrestrained from rotating freely.

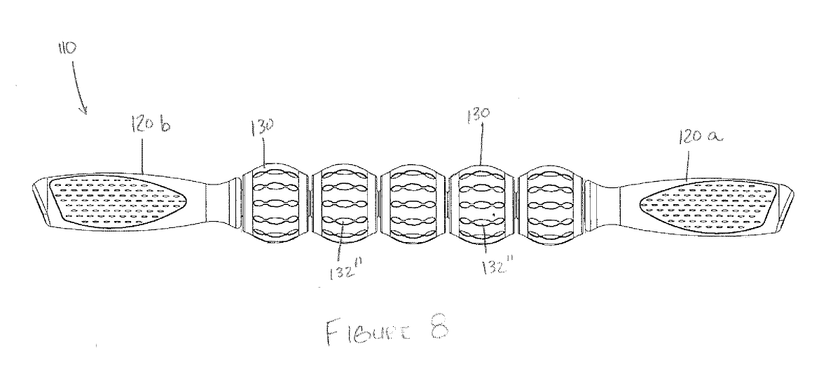

Referring particularly to FIGS. 17-21, the rollers 230 of this embodiment are modified from those of the earlier-described embodiments. In particular, the rollers 230 (at least one of them, anyway) include tissue-gripping surfaces provided by a series of spacer-apart slots 232 that are each elongate extending along a respective centerline 234 that is generally parallel to the central axle 240 and to each other slot's centerline. Thus, the slots 232 are generally axially extending and generally transverse to the direction of rolling across the body area to be treated. The peripheral edge 235 surrounding each of the slots 232, at the interface between the slot and the outer contact surface 231 of the rollers 230, provides a gripping and digging edge for enhanced deep-tissue treatment effects. And with the rollers 230 under pressure against the user's skin, the outer dermal layers are forced into the slots 232, providing for further gripping and digging for enhanced deep-tissue treatment effects.

In the depicted embodiment, the rollers 230 are generally spherical (including spheroidal and other ellipsoidal shapes), with the bottom surfaces of the slots 232 each defining a centerline 236 that also is generally parallel to the central axle 240. In alternative embodiments, the rollers 230 have generally rounded outer contact surfaces 231 but are not spherical. And in other alternative embodiments, the slots 232 have bottom surfaces that are curved such that they define a centerline that is curved circumferentially (so that it's still generally parallel to the central axle 240; similarly to in FIG. 7), that is curved radially (so that it's not generally parallel to the central axle 240), or that is curved both circumferentially and radially.

Referring now particularly to FIGS. 22-28, the handles 220 of this embodiment are also modified from those of the earlier-described embodiments. In particular, the handles 220 include transverse portions 222 that extend transversely related to the central axle 240. In the depicted embodiment, for example, the transverse portions 222 are generally perpendicular to the central axle 240, and the handles 220 each include connector portions 224 that mount between the transverse portions and the central axle with the transverse portions and their respective connector portions (and/or the central axle) together generally T-shaped (see FIGS. 13-14 and 24). In alternative embodiments, the transverse portions and their respective connector portions (and/or the central axle) are together generally Y-shaped or generally L-shaped, with the transverse portions still being transverse relative to the central axle.

In the depicted embodiment, the connector portions 224 each form a loop through which the respective transverse portion 222 extends. And aligned bores through the connector portions 224, the respective transverse portions 222, and the central axle 240 receive a fastener 226 such as an end screw and cap. In an alternative embodiment, the handle of one end is fixed onto the central axle by an adhesive and the handle of the opposite end is mounted to the central axle by a compression cap, such that the handles can rotate relative to each other. In other alternative embodiments, the transverse portions and their respective connector portions are integrally formed together as single pieces, or the connector portions and the central axle are all integrally formed together as a single piece.

Referring now particularly to FIGS. 29-32, the stand 600 of this embodiment is also modified from that of the earlier-described embodiments. In particular, the stand 600 includes two base end portions 640 each with a generally vertical elongate recess 620 for receiving a respective one of the transverse handle portions 222. In addition, the two base end portions 640 are separate pieces, without an intermediate recessed portion connecting them. The generally vertical recesses 620 are formed in top surfaces 642 of the base end portions 640 and are deep enough to receive the transverse portions 222 up to near the central axle 240 and/or the respective connector portion 224, for providing lateral stability when then implement 210 is secured in the stand 600. Bottom surfaces 646 of the base end portions 640 are generally flat for providing lateral stability when the implement 210 is secured in the stand 600. The flat bottom surfaces 646 of the base end portions 640 are generally perpendicular to the generally vertical recesses 620 of the base end portions 640, for providing lateral stability when the implement 210 is secured in the stand 600. And the base end portions 640 are elongated in the direction of rolling to provide lateral stability but relatively narrow in the perpendicular direction for compactness and minimal material cost, tall enough to provide clearance for the rollers 230 above the ground but short enough that they're lateral stable in use so they don't easily tip over, and the vertical recesses 620 for the transverse handle portions 222 are centered in the end portions for lateral stability.

In alternative embodiments, the stand includes an intermediate recessed portion extending between and connecting the two end portions. And in other alternative embodiments, the stand includes only one of the end portions for receiving only one massage implement handle.

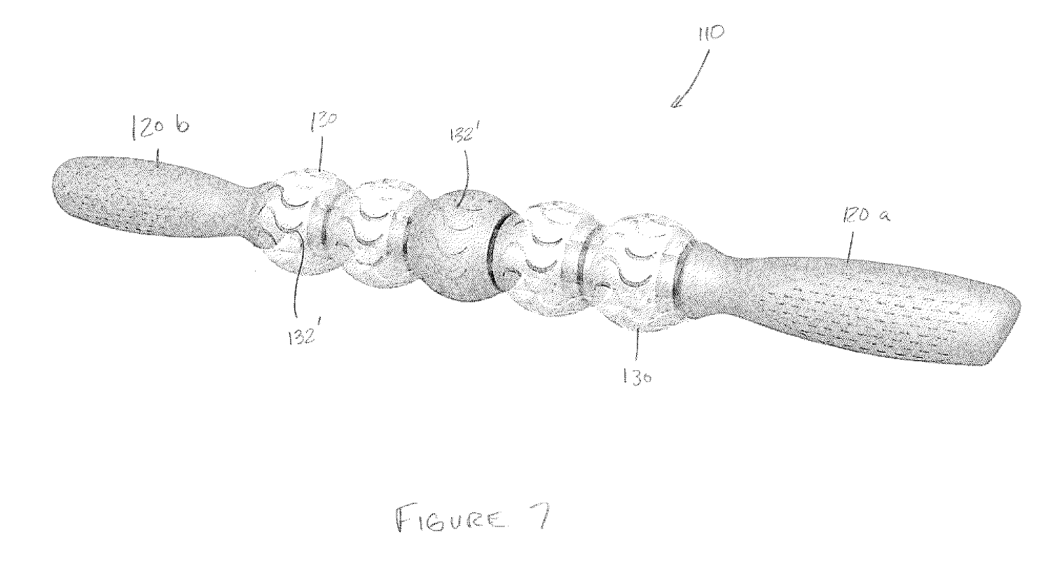

It will be noted that the dimensions shown in FIGS. 14-16, 20-21, 24-28, and 30-31 are provided for illustration purposes only as representative of one example embodiment of the invention. These dimensions are not limiting of the invention, and the invention expressly includes embodiments with other dimensions not shown in the drawings.

Having described details of the structure of the implement 210 and stand 600, methods of using them will now be described. As noted above, the implement 210 can be used by itself, without the stand 600. Such methods can include grasping the transverse handle portions 222, positioning the rollers 230 on a body area to be treated, and applying pressure to handles 220 while moving the rollers back and forth over the body area to be treated. The depicted transverse handle design makes this implement 210 more compact and more ergonomic relative to known devices, and it allows for increased and more precise pressure to be used against the trigger points. This is because, at least in part, the transverse handles 220 allow this implement 210 to be shorter in length relative to designs with linear handles and comparable numbers of comparably sized rollers, and the transverse handles are oriented for more-natural hand placement. And because of the shorter length and the more-natural hand placement, in conjunction with the semi-rigid (or rigid) central axle 240, the user can more easily apply more force to the handles 220 and thus to the rollers 230.

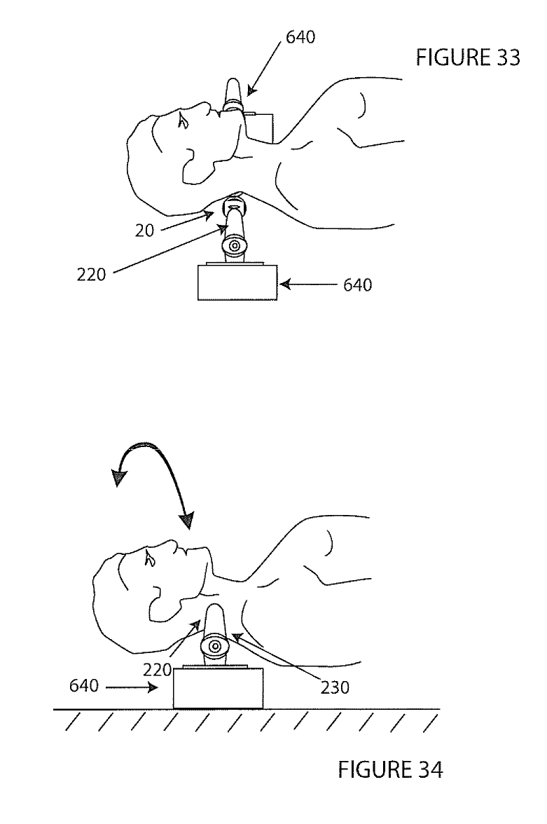

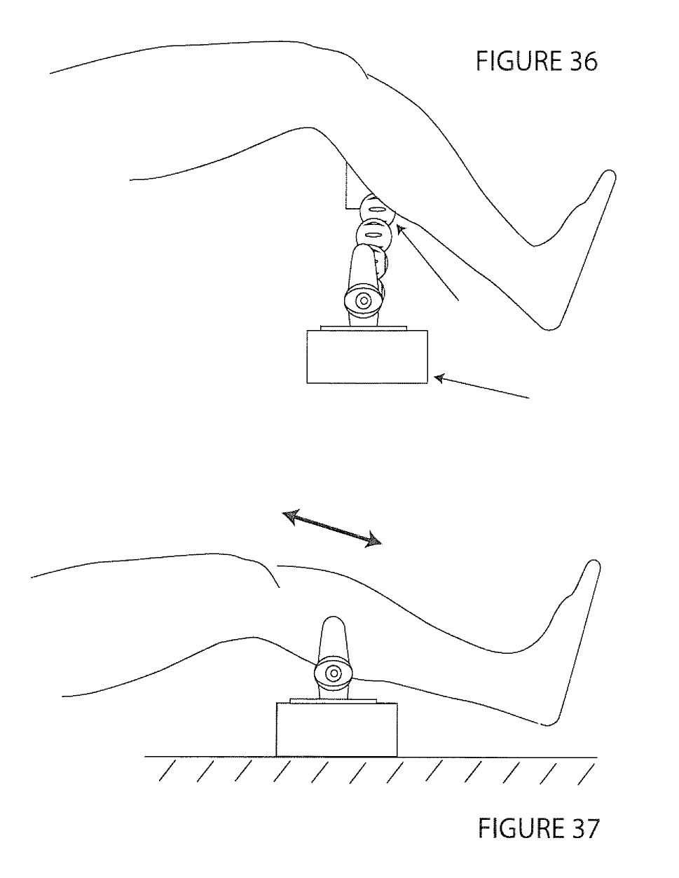

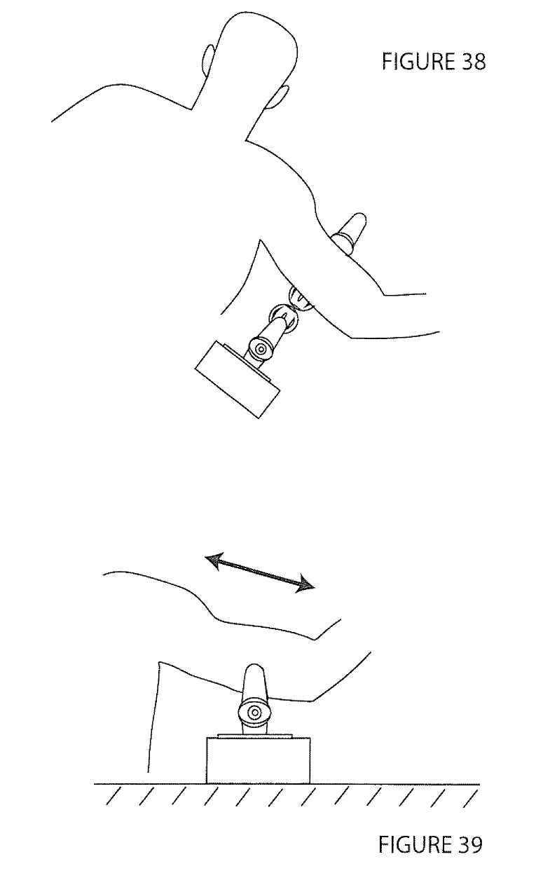

In addition, the implement 210 can also be used in conjunction with the stand 600. Such methods can include supporting the implement 210 on the stand 600 in a fixed position, resting a body area to be treated on top of the rollers 230 so that at least a portion of the user's weight generates a downward force by the body area onto the rollers, and moving the body area back-and-forth across the rollers with the rollers supporting the portion of the user's weight. For example, FIGS. 33-35 show the implement 210 and the stand 600 being used to treat a user's neck, FIGS. 36-37 show the implement and the stand being used to treat a user's leg, and FIGS. 38-39 show the implement and the stand being used to treat a user's arm. Because of the innovative design of the transverse handles 220 and the stability features of the stand base portions 640, a good deal of force can be generated by these rocking motions to provide deep tissue treatments.

In all of these methods of using the implement 210 and/or stand 600, a user is able to “dig” into muscle tissue to help lengthen the muscle fibers, remove scar tissue, alleviate trigger points, increase blood flow to the area, and increase muscle flexibility. In addition to treating the neck, legs, and arms, the invention can be used to treat many other areas of the body, including the back, wrists, heels or arches of the foot, etc.

As noted above, the implement 210 and/or stand 600 can be provided with instructions for using the invention. Such instructions can include guidelines such as those set forth below.
Use medium pressure while rolling out targeted muscles. The goal is to apply pressure to both the facia (the inner webbing that covers all muscles) and the muscles to provide an increase of blood flow to the area. If you roll too lightly, the only benefit is a feel-good massage, not a longer-term muscle therapy. If you roll with too much pressure, you can cause injury and damage to an already sore muscle.
Take your time. While rolling the muscles with the ACTIVE HEALTH ROLLER, be slow and deliberate with your rolling strokes.
Always roll the length of the muscles, and in the same direction of the muscles. Never roll laterally across the length of the muscles. The only side-to-side motion should be when using the CRADLE base stand for treating your calves.
When rolling the calves, place the ACTIVE HEALTH ROLLER in the CRADLE base stand. Rotate the entire leg side to side. Locate and focus on sore areas of trigger points and put more pressure on those areas.
   Of course, these are exemplary guidelines and other specifics can be included, some of the above can be excluded, or both.

It will be understood that the features of the various embodiments described herein can be combined into other embodiments not expressly described herein. That is, one or more of the features of one of the herein-described embodiments can be combined with one or more of the features of another one of the herein-described embodiments or of an embodiment not expressly described herein.

While the invention has been described with reference to example embodiments, it will be understood by those skilled in the art that a variety of modifications, additions, and deletions are within the scope of the invention, as defined by the following claims.

What is claimed is:

1. An implement for massaging muscle tissue, comprising:
an elongated central axle having at least one distal end;
at least one handle coupled to the distal end of the central axle; and
a plurality of rollers rotationally coupled to the central axle, wherein a first one the rollers is operable to rotate independently of a second one of the rollers, and wherein at least the first one of the rollers includes an outer contact surface that is rounded and defines a series of tissue-gripping surfaces.

2. The massage implement of claim 1, wherein the plurality of rollers each have a substantially spherical shape.

3. The massage implement of claim 2, wherein the substantially spherical shape of each of the plurality of rollers is substantially ellipsoidal.

4. The massage implement of claim 1, wherein the tissue-gripping surfaces are provided by elongate slots formed in the contact surface, wherein in use the tissue is forced into the slots to provide for gripping and digging for enhanced deep-tissue treatment effects.

5. The massage implement of claim 4, wherein each of the slots, at a respective interface with the outer contact surface of the respective roller, defines a peripheral edge that surrounds the respective slot to provide a gripping and digging edge for enhanced deep-tissue treatment effects.

6. The massage implement of claim 4, wherein the elongate slots each extend along a respective centerline that is generally parallel to the central axle and to each other slot centerline such that the slots are generally axially arranged and generally transverse to a rolling direction defined by the rollers.

7. The massage implement of claim 1, wherein the at least one handle includes a transverse portion that extends transversely to the central axle.

8. The massage implement of claim 7, wherein the transverse portion is generally perpendicular to the central axle such that the transverse portion and the central axle together are generally T-shaped for compactness and ergonomic gripping.

9. The massage implement of claim 8, wherein the at least one handle comprises a first handle and a second handle, the at least one distal end of the central axle comprises a first distal end and a second distal end, the first handle is coupled to the first distal end of the central axle and the second handle is coupled to the second distal end of the central axle, and the plurality of rollers are coupled to the central axle between the first handle and the second handle.

10. The massage implement of claim 1, wherein the central axle is semi-rigid such that applying force to the at least one handle results in pressure being transferred to the rollers and applied to the tissue with the axle bending/deforming to generally conform to the contour of a treated body area without breaking so that multiple of the rollers contact and treat the body area.

11. The massage implement of claim 1, wherein a central one of the plurality of rollers is larger than the other rollers.

12. The massage implement of claim 1 wherein the rollers are about the same size and shape as golf balls and include a generally tessellated arrangement of dimples.

13. The massage implement of claim 1, wherein the rollers are interchangeable on the central axle.

14. The massage implement of claim 1, wherein the tissue-gripping surfaces are formed as protrusions extending outwardly from the outer contact surfaces of the respective roller.

15. The massage implement of claim 1, wherein the tissue-gripping surfaces are formed as recesses extending inwardly into the outer contact surfaces of the respective roller.

16. A massage system comprising the massage implement of claim 1 in combination with a stand for supporting the implement above a surface for use, the stand comprising at least one base end portion having a flat bottom surface for lateral stability on the support surface when in use and defining at least one recess for receiving at least a portion of the implement such that the implement is secured in a fixed position for use by moving the tissue across the rollers.

17. A massage system for massaging muscle tissue of a body area, comprising:
an massage implement, comprising:
an elongated central axle having first and second distal ends;
first and second handles coupled to the first and second distal ends, respectively, of the central axle, wherein the handles each include a transverse portion that extends generally perpendicularly to the central axle such that the transverse portion and the central axle together are generally T-shaped for compactness and ergonomic gripping; and
a plurality of rollers rotationally coupled to the central axle between the first and second handles, wherein the rollers to rotate independently of each other, wherein the rollers includes an outer contact surface having a substantially ellipsoidal shape and defining a series of elongate slots, wherein the slots each extend along a respective centerline that is generally parallel to the central axle and to each other slot centerline such that the slots are generally axially arranged and generally transverse to a rolling direction defined by the rollers, wherein in use the tissue is forced into the slots to provide for gripping and digging for enhanced deep-tissue treatment effects, wherein each of the slots, at a respective interface with the outer contact surface of the respective roller, defines a peripheral edge that surrounds the respective slot to provide a gripping and digging edge for enhanced deep-tissue treatment effects; and
a stand for supporting the implement above a surface for use, the stand comprising:
first and second base end portions each having a flat bottom surface for lateral stability on the support surface when in use and a top surface, wherein the first and second end portion top surfaces define first and second generally vertical elongate recesses for receiving the first and second transverse handle portions, respectively, with the flat bottom surfaces generally perpendicular to the respective generally vertical recesses, such that the implement is secured in a fixed position on the stand and is laterally stable on the stand for use by moving the body area across the rollers.

18. The massage system of claim 17, wherein the base end portions are elongated in the direction of rolling to provide lateral stability but relatively narrow in the perpendicular direction for compactness and minimal material cost.

19. The massage system of claim 17, wherein the base end portions are tall enough to provide clearance for the rollers above the support surface but short enough that they are laterally stable in use, and the vertical recesses for the transverse handle portions are centered in the end portion top surfaces for lateral stability.

20. A method of massaging muscle tissue of a body area of a user, comprising:
positioning a stand on a support surface;
supporting a massage implement on the stand in a securely fixed position, the massage implement including a central axle, two handles mounted at ends of the axle, and a plurality of rollers rotationally mounted to the axle between the handles;
resting the body area on top of the rollers so that at least a portion of the user's weight generates a downward force by the body area onto the rollers; and
moving the body area back-and-forth in a rocking motion across the rollers with the rollers supporting the portion of the user's weight.
